(19) United States
(12) Patent Application Publication
(10) Pub. No.: US 2019/0102465 A1
(43) Pub. Date: Apr. 4, 2019

(54) API QUERY EXTENSION

(71) Applicant: CA, Inc., New York, NY (US)

(72) Inventors: Yang Yang, Newton, MA (US); Fei Gu, Newton, MA (US); Jason Robert Normandin, Marlborough, MA (US)

(21) Appl. No.: 15/721,558

(22) Filed: Sep. 29, 2017

(51) Int. Cl. G06F 17/30

(52) U.S. Cl. CPC G06F 17/30867; G06F 17/30991

(57) ABSTRACT

Methods, systems, and program products for processing API queries are disclosed. In some embodiments, in response to a data request that is received from a user interface and that includes a first query and one or more extension references, an application modifies the data request by replacing a first extension reference of the one or more extension references with a query post-processing script. In response to receiving the modified data request, an intermediate service transacts the first query with a first data source having a network address included in the modified data request to obtain a first query result. The intermediate service executes the query post-processing script based, at least in part, on the first query result.

### BACKGROUND

The disclosure generally relates to the field of data processing, and more particularly to providing an expanded query interface.

Application program interfaces (APIs) may be characterized as sets of requirements and specifications that govern, as well as the code that implements, how programs interact with each other. In some contexts, APIs enable an application program to interact with another program within a particular processing and/or networking platform such as over a TCP/IP network. Among other interface functions, some APIs implement query functions. For example, so-called Open API (sometimes referred to as public API) encompasses specifications, requirements, and code conforming to those requirements that provides clients with network access to a variety of data and program resources including web services. An open API interface may be configured to implement a query function by providing a mutually compatible format by which a network client can generate and transmit a query conforming to the API protocol to a backend data system such as a database. The backend system utilizes the open API to interpret and execute the query request and return the query results to the network client.

### BRIEF DESCRIPTION OF THE DRAWINGS

Embodiments of the disclosure may be better understood by referencing the accompanying drawings.

FIG. 1 is a block diagram depicting subsystems, devices, and other components for implementing an API data request processing system in accordance with some embodiments;

FIG. 2 is a block diagram illustrating an example API data request processing system in accordance with some embodiments;

FIG. 3 illustrates an example HTTP command including a Universal Resource Locator (URL) and extended query generated by a query application program interface (API) within a networked data processing system in accordance with some embodiments;

FIG. 4 is a flow diagram illustrating operations and functions for generating and processing an API data request within a networked processing environment in accordance with some embodiments;

FIG. 5 is a flow diagram depicting operations and functions for processing API data requests in a distributed data resource environment in accordance with some embodiments; and

FIG. 6 is a block diagram depicting an example computer system that generates and executes API data requests in accordance with some embodiments.

### DESCRIPTION

The description that follows includes example systems, methods, techniques, and program flows that embody embodiments of the disclosure. However, it is understood that this disclosure may be practiced without these specific details. For instance, this disclosure refers to integrating data sources that store computing components and associated performance data in illustrative examples. Aspects of this disclosure can also be applied to other types of data sources in which other types of items are inventoried in association with other types of associated description information. In some instances, well-known instruction instances, protocols, structures and techniques have not been shown in detail in order not to obfuscate the description.

Overview

Systems, methods, devices and other hardware and software components are disclosed and described herein for generating and processing API queries such as may be incorporated within network resource locators. The embodiments described herein address data and processing logic availability related to queries from a client to a backend resource such as a network server. Some embodiments reduce the need to modify either the query initiator client programs or the target backend services/systems to which the queries are sent. To this end, embodiments may include components that generate or re-generate an original query request to include a call to another backend service to retrieve information that may not be available on the target backend system. For example, the client query request may be originally generated using a network resource locator protocol such as a URL that specifies requested information as a parameter within a primary query.

To retrieve information/data associated with the primary query, an extension such as in the form of a query post-processing script may be added to the client request to generate an intermediate query request. In some embodiments, the intermediate query request includes the locator information or address (e.g., network and/or filesystem pathname) of the primary query parameter and further includes a query extension that specifies one or more secondary parameters. In some embodiments, the query extension within the intermediate query request does not including some or all of the locator/address information for the secondary parameter(s).

Example Illustrations

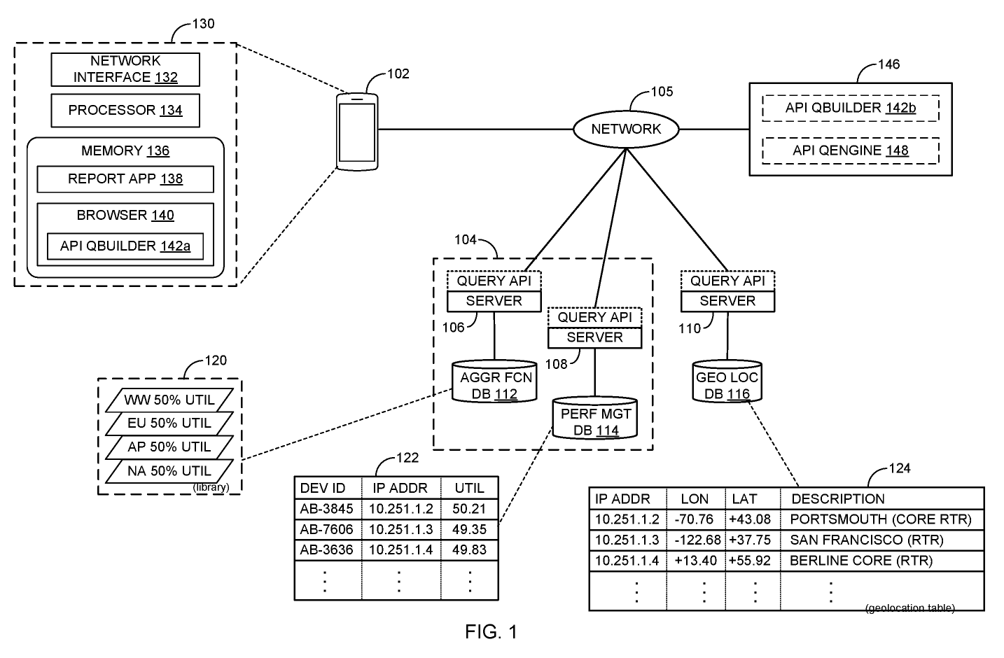

FIG. 1 is a block diagram depicting subsystems, devices, and other components for implementing an API data request processing system in accordance with some embodiments. As shown in FIG. 1, the API data request processing system includes a client device 102 which may be a mobile processing device. Client device 102 includes any combination of hardware and program code for communicating with other nodes via a network 105, which may be a wide area network. Client device 102 includes a network interface 132, a processor 134, and an associated system memory 136 that stores data and system and application software.

Network interface 132 comprises hardware and software components to implement transceiver connectivity and protocol processing to enable mobile device 102 to communicate with network-connected devices. Network interface 132 includes a network interface controller (not depicted) and other devices and logic components for connecting, disconnecting and sending and receiving messages across local and wide area networks. Processor 134 and memory 136 provide additional processing capability necessary for network communications and to enable mobile device 102 to perform other information handling tasks related to, incidental to, or unrelated to the methods described herein. Mobile device 102 may be a smartphone or other type of mobile phone or highly integrated portable device or any other type of portable electronic programmed device having network connectivity.

Mobile device 102 is configured to execute a report application 138 that includes program instructions and data for accessing and retrieving information from other network-connected nodes such as a server 110 and one or more of servers 106 and 108 within a backend system 104. For example, report application 138 may be configured to retrieve infrastructure management data that may be gathered by and stored within databases 112 and 114. In the depicted embodiment, database 114 receives and stores performance management data such as may be generated by a performance monitoring system (not depicted) that monitors computing and networking systems, devices, and programs. Database 114 includes a table 122 for storing performance data in association with information that identifies or otherwise describes the particular devices being monitored. Table 122 includes multiple row-wise records that each include a device ID field, an Internet Protocol (IP) address field, and a utilization field. For instance, the second row-wise record of table 122 associates device ID AB-7606 with IP address 10.251.1.3 and a utilization metric of 49.35%.

In the depicted embodiment, server node 110 is a geolocation server node and backend system 104 is an infrastructure management backend system comprising server nodes 106 and 108. Each of server nodes 106, 108, and 110 includes server platform hardware and software for responding to client data retrieval requests for information stored within databases 112, 114, and 116, respectively. Server nodes 106, 108, and 110 each include a query API interface, such as a REST API, configured to read, process, and respond to API queries, such as HTTP formatted queries. For example, network nodes may generate and transmit HTTP queries to server nodes 106, 108, and 110 as URLs that include a query portion in addition to a web address. To this end, each of server nodes 106, 108, and 110 includes program constructs for communicating with network nodes such as client node 102 including respective APIs by which, for example, a server node can respond to client-side API requests. Database 116 receives and stores geographic location information that may be associated with global IP addresses including IP addresses of systems and devices tracked within database 114. Within backend system 104, database 112 stores a set of data aggregation scripts that are configured to calculate or otherwise algorithmically determine statistics and other results from performance metric data such as the utilization data stored within database 114.

As shown, database 112 includes a library 120 containing multiple utilization functions including a utilization function applied to devices located worldwide. Specifically, the depicted worldwide aggregation function is programmed to identify and collect the identifiers (IDs) and possibly additional system/device information for all systems and devices having a utilization metric of at least 50%. Library 120 further includes aggregation function scripts that are programmed to determine similar information for systems and devices located in European Union (EU), Asia Pacific (AP), and North America (NA) geographic regions. Database 116 includes a geolocation table 124 that includes multiple row-wise records that each include an IP address field, a longitude field, a latitude field, and a description field. For example, the first row-wise record of table 124 associates IP address 10.251.1.2 with a longitude value −70.76, a latitude value +43.08, and a geo description “PORTSMOUTH (CORE RTR).”

Each of the servers 106, 108, and 110 hosting databases 112, 114, and 116 include a respective query API for processing client API requests including data retrieval requests. Mobile device 102 includes an API query communication interface within a browser 140 that implements a query API such as a REST API. Report application 138 may generate a data retrieval request from user interface (UI) input and deliver the request via browser 140. In the depicted embodiment, browser 140 includes an API query builder 142a comprising program code configured to generate a modified API data request in accordance with the operations and functions disclosed herein. In one aspect, API query builder 142a receives from report application 138 an API data request such as may be implemented as an HTTP URL. The data request may be received by API query builder 142a from a UI generated by report application 138 in response to, for example, user selection of a graphically displayed data request object.

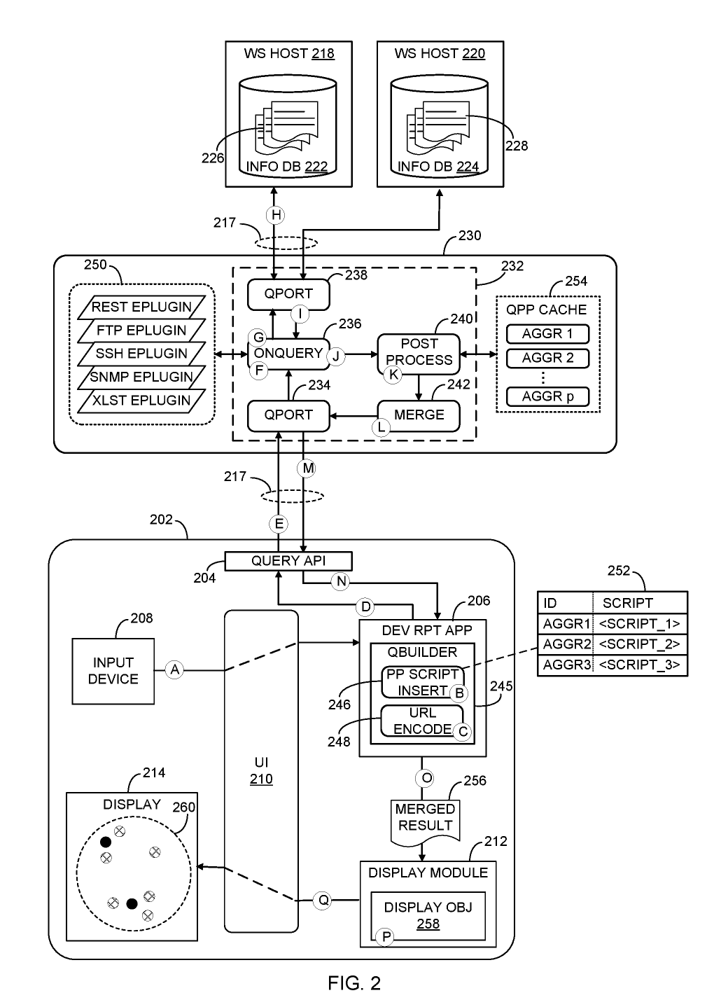

As depicted and described in further detail with reference to FIGS. 2-5, the data request may include a query portion such as a query requesting specified information items. For example, the query may include a network address (e.g., address portion of query URL) of a backend system/device such as one of servers 106, 108, or 110. In association with the network address, the query further includes a requested information specifier such as a parameter ID. For example, if the query network address is the address for server 108, the requested information specifier may be a device ID variable and/or a utilization metric variable included in a storage pathname. The data request further includes an extension reference that is associated with the query portion. As depicted and described in further detail with reference to FIGS. 2-5, the extension reference is essentially a fixed ID of a query post-processing script and is initially included in the data request by whichever client application (e.g., report application 138) initially generates the data request. The post-processing script identified by or within the extension reference conforms to a particular API format and protocol, typically the same API format and protocol that the client device uses to send the overall data request, such as REST.

In accordance with some embodiments, the data request generated by report application 138 is received and processed by API query builder 142a to generate a modified data request. Specifically, API query builder 142a is configured to parse the data request to determine whether the request includes an extension reference. In response to determining and locating the extension reference, API query builder 142a replaces the extension reference within the request with a query post-processing script corresponding to the extension references. In some embodiments, the query post-processing script includes instructions for implementing a secondary or otherwise supplemental query with respect to the query included in the original, unmodified data request. In the same or alternate embodiments, the query post-processing script includes instructions for calculating or otherwise computing a result based on processing the original or supplemental query results using a specified function or algorithm.

Having identified the request as including the extension reference and having modified the request accordingly, API query builder 142a encapsulates the modified data request within a higher-order (first to be processed in accordance with network and transport protocol) intermediate query service request. The intermediate service request may comprises a URL request conforming to HTTP that includes a network address of a system 146 that hosts an intermediate query service. The intermediate query service includes an API query engine 148 and, in embodiments in which an API query builder is not implemented by the client node, may further include an API query builder 142b. API query engine 148 includes any combination of program code constructs for transacting the original information query included in the unmodified data request with the data source (e.g., backend system) to which the original information query is directed. API query engine 148 is further configured to execute the query post-processing script inserted into the modified data request by either API query builder 142a or 142b.

As depicted and described in further detail with reference to FIGS. 2-5, API query engine 148 is configured to, in conjunction with the original query transaction, execute the query post-processing script based, at least in part, on the information results of the original query transaction. For instance, query engine 148 may receive a modified data request that includes an original information query directed via URL address to server node 108 or performance management database 114 and via implicit HTTP method protocol or express instruction requests device IP addresses stored by database 114. Query engine 148 transacts the information query with server 108 to retrieve a query result that includes a list of device IDs including AB-3845, AB-7606, and AB-3636 and corresponding IP addresses 10.251.1.2, 10.251.1.3, and 10.251.1.4.

Query engine 148 processes the IP addresses portion of the query result to reform the query post-processing script, which may be in template or variable form into a form that may be executable to obtain results based on the original query results. For example, query engine 148 may include IP addresses 10.251.1.2, 10.251.1.3, and 10.251.1.4 as arguments in the query post-processing script which is then executed by query engine 148. Continuing with the example, the query post-processing script may include the URL address of server 110 or geolocation database 116 and may further include instructions for retrieving longitude and latitude information stored in database 116. Query engine 148 begins execution of the query post-processing script by parsing the script content and/or the instruction portion of the original query and/or the information included in the query result to identify one or more dependencies between the script and the instruction portion of the query and/or information contained in the query result. For example, query engine 148 may identify as a dependency the match between a requested item specified as a variable in the query post-processing script and the same or similar variable specified in the original query.

Query engine 148 may utilize the identified dependencies to determine the manner in which to execute the query post-processing script. For instance, query engine 148 may determine, in accordance with the identified dependencies that a supplemental query is required. In response, query engine 148 generates a supplemental information query having instruction content that depends on the identified dependencies, the original query results, and/or portions of the query post-processing script itself. For embodiments in which the post-processing script includes a data processing function, execution by query engine 148 of the script includes applying a portion of the received query results as operands processed by the data processing function to generate a post-processing result.

Query engine 148 generates a supplemental query and/or performs a data processing function on the original query results in accordance with the reformed query post-processing script. The results of the supplemental query and/or post-query processing function are merged and transmitted to report application 138 within client device 102.

FIG. 2 is a block diagram illustrating an example system that includes subsystems, devices, and other components for processing data requests including generating and processing API query extensions in accordance with some embodiments. The components of the system depicted in FIG. 2 may be implemented in the network environment depicted in FIG. 1. The system includes a client system 202 that is configured using any combination of hardware and program code constructs to execute system and application software including a device report application 206. Device report application 206 may be configured to request or otherwise access infrastructure management data such as device ID, IP addresses, and performance metrics collected by a monitoring system (not depicted). Device report application 206 includes a UI layer 210 that provides an I/O interface for users of client system 202.

Client system 202 includes a user input device 208 such as a keyboard and/or display-centric input device such as a screen pointer device. A user can use input device 208 to enter commands (e.g., displayed object select) or data that are processed via a UI layer 210 and received by the system and/or application software executing within the processor-memory architecture (not expressly depicted) of client system 202. User input signals from input device 208 may be translated as keyboard or pointer commands directed to device report application 206. In some embodiments, device report application 206 is configured, in part, to generate graphical objects, such as a management display object 258 by a display module 212. Graphical representations of management display object 258 are rendered via UI layer 210 on a display device 214, such as a computer display monitor.

Device report application 206 is further configured to include a query builder module 245 that may be configured to perform the operations and functions described with reference to FIGS. 1, 4, and 5. Among other program components, device report application 206 includes a post-processing script insert unit 246 and a URL encode unit 248. Post-processing script insert unit 246 includes program instructions for processing a data request received via UI layer 210, such as may be selected or otherwise generated by input device 208. In some embodiments, script insert unit 246 includes code for parsing the data request to determine whether the request includes a query extension reference and replacing the extension reference with a corresponding post-processing script. URL encoding unit 248 includes program instructs for re-encoding a modified data request generated by script insert unit 246 to conform to a network protocol used to communicate with other network nodes.

Client system 202 further includes a query API 204 for communicating over a network 217 with an intermediate query service 230. In some embodiments, intermediate query service 230 includes program components and data that may be hosted by a server processing platform the components of which are not depicted to avoid obfuscation of the operational principles and system configuration features described herein. Intermediate query service 230 includes a query engine 232 that is configured using various program and data constructs to receive and process modified data requests generated by the query builder 245 within client 202. The modified query processing includes transacting an information query included in the original (i.e., UI provided) data request and, in conjunction with the query transaction, executing a post-processing script included in the modified data request.

Intermediate query service 230 transacts the information query with a backend data source such as one of web service hosts 218 and 220 that are communicatively coupled to intermediate query service 230 via network 217. Each of web service hosts 218 and 220 comprise any combination of hardware, program code, and data for retrieving and storing information within respective information databases 222 and 224.

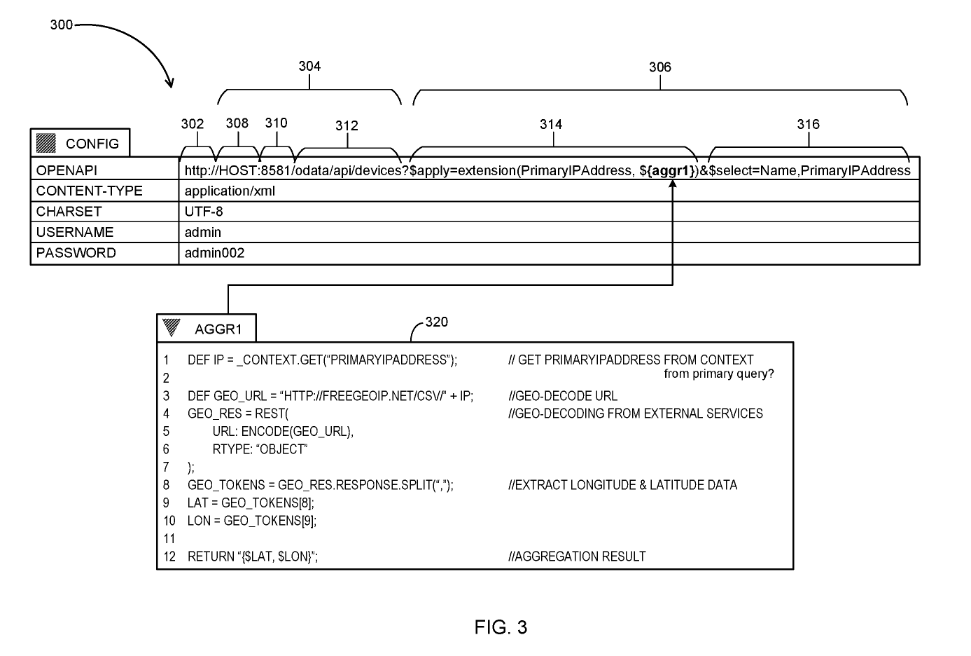

Referring to FIG. 3, a representation is depicted of some of the components within a UI-supplied data request and a modified data request that may be processed by devices and components illustrated in FIG. 2. FIG. 3 depicts a code development object 300 containing an example HTTP command including a URL and extended query such as may be generated by a query API within a networked data processing system in accordance with some embodiments. Code development object 300 may be generated and displayed such by an integrated development environment (IDE) code development tool and includes several sections that define, describe, and otherwise characterize a data request implemented as an HTTP command.

As shown, the HTTP command itself is defined as being an OpenAPI protocol data request. Some of the description/definition sections include a content definition section defining the content of the data request as XML application type. Other sections define the username “admin,” the password “admin002,” and character set as UTF-8. The HTTP command comprising the example data request includes a scheme portion 302 defining the command as an HTTP command. The HTTP command further includes a Uniform Resource Locator (URL) portion 304 and an extended query portion 306. URL portion 304 comprises a host field 308 that specifies a host ID for a system or device to which a primary query 316 within the extended query portion 306 is directed.

URL portion 304 further includes a port field 310 and a path field 312. Port field 310 specifies “8581” as the numeric ID for the host port to which the primary query is to be transmitted. Path field 312 specifies a data management path (e.g., file system path) “/odata/api/devices?” as the host path to be accessed to retrieve data requested per the primary query 316. In addition to primary query 316, extended query portion 306 includes a query extension portion 314 that specifies a query extension reference, “aggr1,” within the context in which the extension is applied with respect to primary query 316.

Referring back to the system depicted in FIG. 2, the HTTP command depicted in FIG. 3 is processed by both the query builder 245 within device report application 206 and the query engine 232 within intermediate query service 230. To implement the data request processing function, query builder 245 and query engine 232 perform steps of modifying the HTTP command and processing the modified command in order to efficiently implement a query extension interface as now explained in an example description of a series of operations and functions.

FIG. 2 is annotated with a series of letters A-Q. These letters represent stages of operations performed during one or more of a portion of an API query processing cycle. Although these stages are ordered for this example, the stages illustrate one example to aid in understanding this disclosure and should not be used to limit the claims. Subject matter falling within the scope of the claims can vary with respect to the order and some of the operations.

At stage A, a data request input using input device 208 via UI 210 is received by query builder 245 within device report application 206. For this example operation series example, the data request comprises the HTTP command depicted in FIG. 3 which includes a URL query portion comprising “http://HOST:8581/odata/api/device?”. As illustrated in FIG. 3, the URL query portion corresponds to and includes scheme portion 302, host ID portion 308, port ID portion 310, and path 312. At stage B, post-processing script insert unit 246 parses the data request to determine whether the request includes an extension reference. If so, and continuing with stage B, script insert unit 246 accesses an extension script table 252 to identify a post-processing script that corresponds to the extension reference within the data request.

In the depicted embodiment, extension script table 252 includes multiple row-wise records that each include a script ID index field associated with a script content field. For example, the first record of extension script table 252 specifies “aggr1” as the ID corresponding to the extension reference “aggr1” within the HTTP command shown in FIG. 3. Associated within the table record with the “aggr1” script ID is the script content, represented in FIG. 2 as “<SCRIPT_1>.” The depicted <SCRIPT_1>content represents post-process script code depicted in FIG. 3 as the code within a script code template 320. As shown in FIG. 3, the script code is initially a template that, at line 1, specifies an IP address variable “IP” as being defined to be the “PRIMARY ADDRESS” to be obtained via the “CONTEXT.GET” instruction from the results of primary query 316.

At line 3, the script code template 320 further specifies the variable GEO _URL as being defined to include the geo-decoded URL information for the IP addresses obtained as “PRIMARY ADDRESS” from the results of the primary query 316. At lines 4-7, script code template 320 includes a REST extension plugin for URL encoding each of the GEO_URL results (i.e., each of the geo-decoded URLs for each IP address in the results for primary query 316). At lines 8-10, script code template 320 defines the variables “GEO-TOKENS” to be the result of a function “GEO RES.RESPONSE.SPLIT(”,“)” that is configured to extract longitude and latitude information for each of the geo-decoded URLs. At line 12, script code template 320 includes a RETURN instruction for returning the extracted longitude and latitude values as matched pairs corresponding to each geo-decoded URL.

Referring to FIG. 2, and continuing with stage B, post-processing script insert unit 246 modifies the data request (e.g., HTTP command) by replacing the extension reference “{aggr1}” with the script code template 320. At stage C, URL encode 248 URL encodes (sometime referred to as percent encoding) the resultant modified data query for transmission across network 217. The URL encoded data request is sent to a query API 204 at stage D and forwarded to a query port 234 that is within the configuration of query engine 232 (stage E). The data request is decoded by query port 234 and next received and processed by an on query unit 236 within query engine 232.

Onquery unit 236 includes program instructions for processing the received modified data request during a first phase. At stage F, onquery unit 236 reads the modified data request to determine the format and protocol of some or all of the modified data request. In particular, onquery unit 236 determines the processing protocol of the post-processing script template and accesses an extension plugin library 250 to select a corresponding extension plugin. Continuing with the example, onquery unit 236 determines that post-processing script template 320 conforms to HTTP REST protocol and, in response, identifies and selects the REST EPLUGIN extension plugin to be used to process portions of the modified data request including the post-processing script template. The REST extension plugin is executed to process the modified data request including transacting primary query 316 with web services host 218.

Transacting the query includes identifying the target IP address of primary query 316 as comprising the URL portion 304 and sending the primary, information query 316 to query port 238 (stage G). At stage H, primary query 316 is transmitted to web services host 218 which processes the query and returns the query results in the form of one or more IP addresses of devices to query engine 232 where it is received by onquery unit 236 at stage I. Onquery unit 236 passes the query results and portions of the modified data request including the post-processing script template to a post process routine 240 (stage J). At stage K, post process routine 240 executes the post-processing script using the template and the query results as input. For example, post process routine 240 may utilize the IP addresses obtained from the initial query as operands in the “PrimarylPAddress” field of the query extension 314 and/or script template code 320. In some embodiments, post process routine 240 may access a query post-processing library 254 that stores multiple post-processing routines and functions. For example, intermediate query service 230 may further include program code components that may be executed to accumulate post-processing scripts that are received from client nodes such as client system 202.

Having executed the post-processing script, the results from post-processing and from the original query are merged by merge routine 242 and sent to query port 234 (stage L). The merged results are transmitted from query port 234 to query API 204 (stage M), which forwards the merged results to device report application 206 (stage N). At stage 0, device report application 206 sends the merged results to display module 212 which generates display object therefrom (stage P). The display object is then rendered on display device 214 as a management graphical object 260 (stage Q).

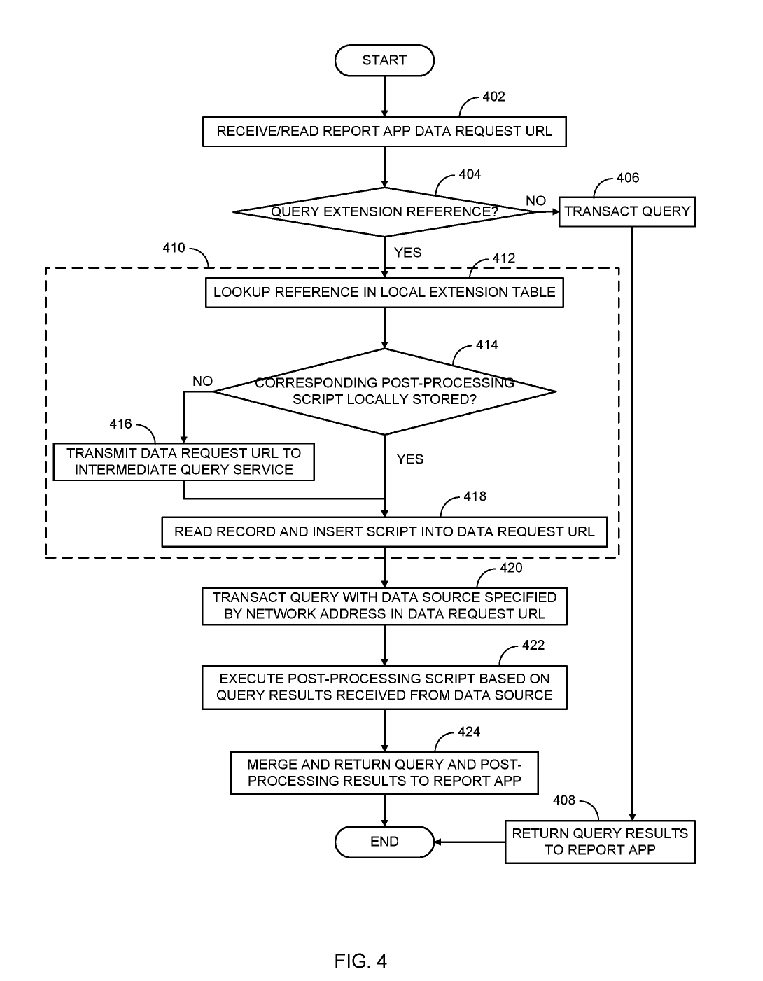

FIG. 4 is a flow diagram illustrating operations and functions for generating and processing an API data request within a networked processing environment in accordance with some embodiments. The operations and functions depicted in FIG. 4 may be performed by one or more of the systems, devices, and components illustrated and described with reference to FIGS. 1-3. The process begins as shown at block 402 with a query builder program component such as may be implemented as part of a report application receiving and reading a data request from a report application. In some embodiments, the data request may comprise a query URL conforming to HTTP REST protocol. The data request includes a first information query such as a query that requests specified information items such as IP addresses corresponding to network devices. Associated with the first information query within the data request is a network address (e.g., address portion of URL). The extension reference may comprise a fixed text symbol associated, based on the data request protocol (e.g., REST), with an extension indicator.

At block 404, the query builder determines whether or not the data query includes an extension ID. In some embodiments, the query builder may include a parsing component for parsing and comparing symbols within the data request to identify an extension reference. In other embodiments, the query builder determines that the data request includes an extension reference by reading the protocol specific extension indicator that is associated with the fixed text symbol representing the reference. In response to determining that the data request does not include an extension reference, the query builder returns control to other components of the report application which transact the query with the addressed data source (block 406). The transacting of the query concludes with the data source returning query results to the requesting report application (block 408).

In response to the query builder determining at block 404 that the data request includes an extension reference, control passes to superblock 410 with a sequence of operations for modifying the data request by replacing the extension reference with a query post-processing script. The modification sequence begins at block 412 with the query builder performing a lookup to locate script code corresponding to the extension reference. For example, the query builder may access a local extension reference table such as table 252 in FIG. 2 and use the extension reference ID or other symbol as an index to locate a corresponding script. As shown at steps 414 and 418, in response to identifying a corresponding post-processing script locally, the query builder selects and inserts the script into the data request. In response to the query builder determining at block 414 that a corresponding script is not locally available, the data request is transmitted to an intermediate query service that maintains a list of post-processing scripts one of which may correspond to the extension reference.

Following modification of the data request at blocks 412 through 418, the modified data request is transmitted to a query engine within an intermediate query service. At block 420, the query engine transacts the original information query with the data source having a network address that is included in the original, unmodified data request. The query transaction concludes with the data source returning query result information to the query engine. At block 422, the query engine executes the post-processing script within the modified data request based, at least in part, on the query result information received from the data source. The process concludes at block 424 with the query engine merging results from executing the post-processing script execution and the query result information and transmitting the merged information to the report application.

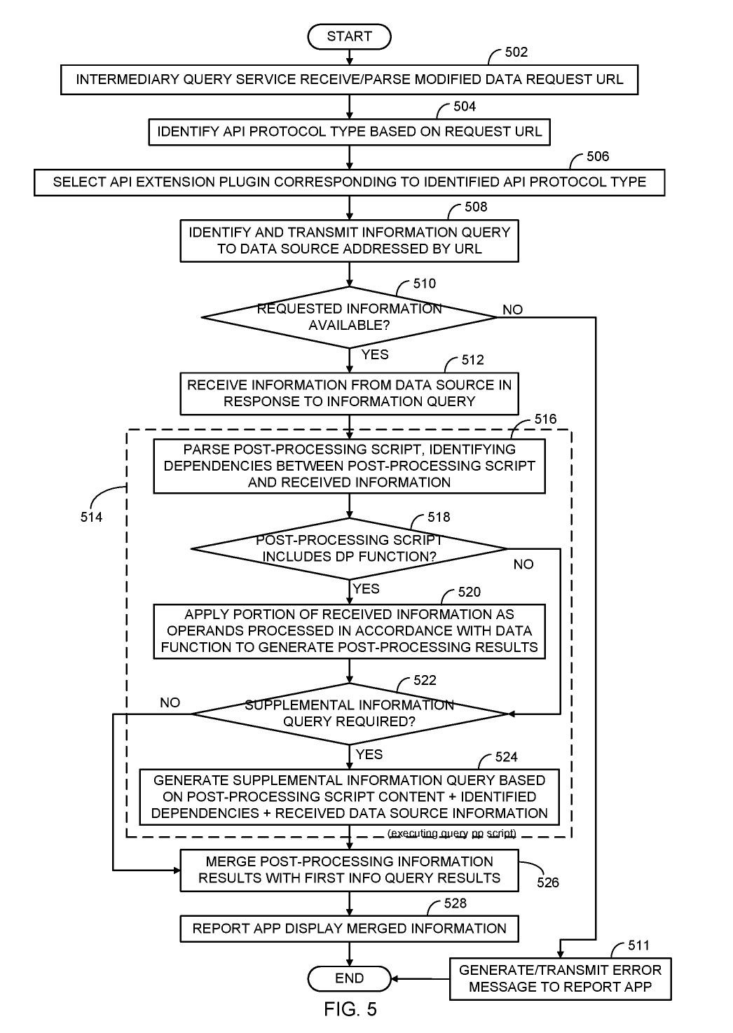

FIG. 5 is a flow diagram depicting operations and functions for processing API data requests in a distributed data resource environment in accordance with some embodiments. The operations and functions depicted in FIG. 5 may be performed by one or more of the systems, devices, and components illustrated and described with reference to FIGS. 1-4. The process begins as shown at block 502 with an intermediate query service receiving and parsing a modified data request. In some embodiments, and as described with reference to FIGS. 1-4, the modified data request may be generated by a query builder executing from a client application platform or within the intermediate query service. Based on the parsing, a query engine within the intermediate query service identifies an API protocol type based on a URL and or other portions of the modified data request (block 504).

At block 506, the query engine selects an API extension plugin executable corresponding to the identified API protocol type. For example, in response to identifying the modified data request or the post-processing script portion as conforming to the HTTP REST protocol, the query engine selects a REST extension plugin to execute at least the post-processing script portion of the modified data request. In addition to selecting a plugin to execute the post-processing script, the query engine begins execution of the overall data request by identifying and transmitting the information query portion of the data request to a data source identified by the network address contained in the request (block 508).

Continuing as shown at blocks 510 and 511, if the information requested in the information query is not available at the data source, the intermediate query service generates and transmits an error message to the client application. If the information is available as determined at block 510, the query engine receives the information results from the data source at block 512. Next, as shown at superblock 514, the query engine executes a series of operations for executing the query post-processing script. The post-processing script execution sequence begins as shown at block 516 with the query engine parsing the post-processing script and original query instructions and, in some embodiments, the result information received from the data source to identify dependencies between the post-processing script and either or both portions of the original query instructions and the received result information. Proceeding as shown at block 518, the query engine determines whether or not the post-processing script includes a data processing function. Example data processing functions include aggregate data functions such as algorithms to determine max, min, average, etc.

In response to determining that the post-processing function includes a data processing function, the query engine applies a portion of the received query result information as operands to be processed in accordance with the identified data function (block 520). Following the query engine processing the received query result information as operands to generate post-processing results, the query engine determines whether an additional information query is specified or otherwise required by the post-processing script (block 522). In response to determining at block 522 that an additional query is required, the query engine concludes the query post-processing script execution sequence by generating a supplemental information query (block 524) based on the content of the post-processing script, the dependencies identified at block 516, and the result information received from the data source at block 512. The query engine transacts the supplemental query including determining a data source address from the post-processing script (e.g., HTTP://FREEGEOIP.NET in FIG. 3) and transmitting the supplemental query to the data source. The query engine receives resultant query results from the data source. At block 526, the query engine merges the first query results with the processing results from block 522 and/or the supplemental query results and transmits the merged information results to the client application. The process concludes with the client application (e.g., report application) displaying the merged information on a computer display device (block 528).

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality provided as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

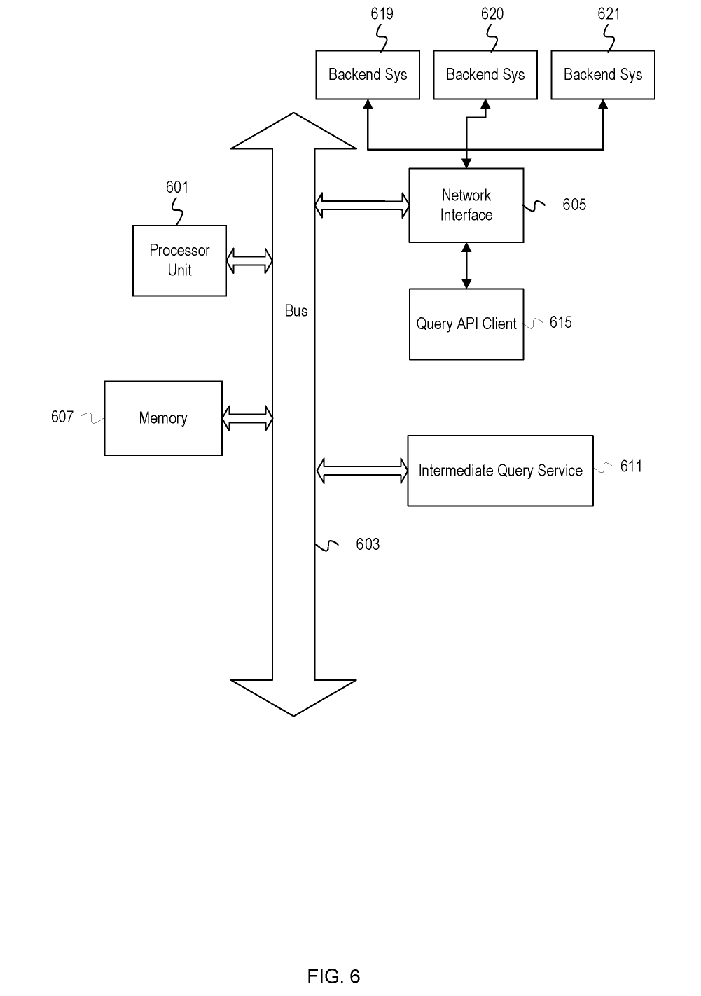

FIG. 6 is a block diagram depicting an example computer system that generates and executes API queries in accordance with some embodiments. The computer system includes a processor unit 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport® bus, InfiniBand® bus, NuBus, etc.) and a network interface 605 (e.g., a Fiber Channel interface, an Ethernet interface, an internet small computer system interface, SONET interface, wireless interface, etc.). The system also includes query generation and processing components within a query API client 615 and an intermediate query service 611 such as may incorporate the systems, devices, and components depicted and described with reference to FIGS. 1-5. The intermediate query service 611 provides program structures for generating and processing API queries as described with reference to FIGS. 1-5. To this end, the intermediate query service 611 may incorporate and/or utilize some or all of the system, devices, components, and data structures described in FIGS. 1-5. Communicatively coupled to the integration layer via network interface 605 is query API client 615 and multiple backend systems 619, 620, and 621.

Any one of the previously described functionalities may be partially (or entirely) implemented in hardware and/or on the processor unit 601. For example, the functionality may be implemented with an application specific integrated circuit, in logic implemented in the processor unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601 and the network interface 605 are coupled to the bus 603. Although illustrated as being coupled to the bus 603, the memory 607 may be coupled to the processor unit 601.

While the aspects of the disclosure are described with reference to various implementations and exploitations, it will be understood that these aspects are illustrative and that the scope of the claims is not limited to them. In general, techniques for generating and processing API queries as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality shown as separate components in the example configurations may be implemented as a combined structure or component. Similarly, structures and functionality shown as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, Cl or any combination thereof, including multiples of any element.

What is claimed is:

1. A method for processing queries, said method comprising:
in response to a data request that is received from a user interface and that includes a first query and one or more extension references, an application modifying the data request by replacing a first extension reference of the one or more extension references with a query post-processing script; and
in response to receiving the modified data request, an intermediate service,
transacting the first query with a first data source having a network address included in the modified data request to obtain a first query result; and
executing the query post-processing script based, at least in part, on the first query result.

2. The method of claim 1, wherein said modifying the data request comprises:
accessing records that map each of multiple query post-processing scripts to a respective one of multiple extension references;
locating a record that maps the query post-processing script to the first extension reference; and
inserting into the data request outside of the first query, the query post-processing script that is mapped to the first extension reference.

3. The method of claim 1, wherein the first query comprises an information query and wherein the data request specifies the network address of the first data source, said transacting the first query comprising:
transmitting the information query to the first data source; and
receiving first information within the first query result from the first data source in response to the information query.

4. The method of claim 3, wherein said executing the query post-processing script comprises parsing the query post-processing script and the received first information to identify one or more dependencies between the query post-processing script and the received first information.

5. The method of claim 4, wherein the query post-processing script includes a data processing function, said executing the query post-processing script further comprising applying a portion of the received first information as operands processed by the data processing function to generate a post-processing result.

6. The method of claim 4, wherein said executing the query post-processing script further comprises:
determining, based on at least one of the identified dependencies, whether a supplemental information query is required; and
in response to determining that a supplemental information query is required, generating the supplemental information query based on content of the query post-processing script, the at least one of the identified dependencies, and the received first information.

7. The method of claim 1, further comprising:
obtaining post-processing information from said executing the query post-processing script;
merging information within the first query result with the post-processing information; and
the application displaying the merged information.

8. The method of claim 1, further comprising:
transmitting the modified data request to an intermediate query service that includes API extension plugins for one or more API protocols; and
the intermediate query service,
identifying an API protocol type based on the modified data request;
selecting an API extension plugin corresponding to the identified API protocol; and
executing the modified data request using the selected API extension plugin.

9. One or more non-transitory machine-readable media comprising program code for processing queries, the program code to:
in response to a data request that is received from a user interface and that includes a first query and one or more extension references, modify the data request by replacing a first extension reference of the one or more extension references with a query post-processing script; and
in response to receiving the modified data request,
transact the first query with a first data source having a network address included in the modified data request to obtain a first query result; and
execute the query post-processing script based, at least in part, on the first query result.

10. The machine-readable media of claim 9, wherein the program code to modify the data request comprises program code to:
access records that map each of multiple query post-processing scripts to a respective one of multiple extension references;
locate a record that maps the query post-processing script to the first extension reference; and
insert into the data request outside of the first query, the query post-processing script that is mapped to the first extension reference.

11. The machine-readable media of claim 9, wherein the first query comprises an information query and wherein the data request specifies the network address of the first data source, the program code to transact the first query comprising program code to:
transmit the information query to the first data source; and
receive first information within the first query result from the first data source in response to the information query.

12. The machine-readable media of claim 11, wherein the program code to execute the query post-processing script comprises program code to parse the query post-processing script and the received first information to identify one or more dependencies between the query post-processing script and the received first information.

13. The machine-readable media of claim 12, wherein the program code to execute the query post-processing script further comprises program code to:
determine, based on at least one of the identified dependencies, whether a supplemental information query is required; and
in response to determining that a supplemental information query is required, generate the supplemental information query based on content of the query post-processing script, the at least one of the identified dependencies, and the received first information.

14. The machine-readable media of claim 9, wherein the program code further includes program code to:
obtain post-processing information from said executing the query post-processing script;
merge information within the first query result with the post-processing information; and
display the merged information.

15. The machine-readable media of claim 9, wherein the program code further includes program code to:
transmit the modified data request to an intermediate query service that includes API extension plugins for one or more API protocols; and
identify an API protocol type based on the modified data request;
select an API extension plugin corresponding to the identified API protocol; and
execute the modified data request using the selected API extension plugin.

16. An apparatus comprising:
a processor; and
a machine-readable medium having program code executable by the processor to cause the apparatus to:
in response to a data request that is received from a user interface and that includes a first query and one or more extension references, modify the data request by replacing a first extension reference of the one or more extension references with a query post-processing script; and
in response to receiving the modified data request,
transact the first query with a first data source having a network address included in the modified data request to obtain a first query result; and
execute the query post-processing script based, at least in part, on the first query result.

17. The apparatus of claim 16, wherein the first query comprises an information query and wherein the data request specifies the network address of the first data source, the program code further comprising program code to cause the apparatus to:
transmit the information query to the first data source; and
receive first information within the first query result from the first data source in response to the information query.

18. The apparatus of claim 17, the program code further comprising program code to cause the apparatus to parse the query post-processing script and the received first information to identify one or more dependencies between the query post-processing script and the received first information.

19. The apparatus of claim 18, the program code further comprising program code to cause the apparatus to:
determine, based on at least one of the identified dependencies, whether a supplemental information query is required; and
in response to determining that a supplemental information query is required, generate the supplemental information query based on content of the query post-processing script, the at least one of the identified dependencies, and the received first information.

20. The apparatus of claim 16, the program code further comprising program code to cause the apparatus to:
transmit the modified data request to an intermediate query service that includes API extension plugins for one or more API protocols; and
identify an API protocol type based on the modified data request;
select an API extension plugin corresponding to the identified API protocol; and
execute the modified data request using the selected API extension plugin.
